(19) United States
(12) Patent Application Publication
(10) Pub. No.: US 2019/0044355 A1
(43) Pub. Date: Feb. 7, 2019

(54) BATTERY UNIT MAINTENANCE SYSTEM

(71) Applicant: GENERAL ELECTRIC COMPANY, Schenectady, NY (US)

(72) Inventors: Emma Elina Ikonen, Espoo (FI); Jun Hou, Shanghai (CN); Kristian Matti Karru, Kirkkonummi (FI); Lei Xia, Shanghai (CN)

(73) Assignee: GENERAL ELECTRIC COMPANY, Schenectady, NY (US)

(21) Appl. No.: 15/755,966

(22) PCT Filed: Aug. 28, 2015
(86) PCT No.: PCT/US15/47364

§ 371 Date: Feb. 27, 2018

(51) Int. Cl. H02J 7/00; H01M 10/44; H01M 10/42

(52) U.S. Cl. CPC H02J 7/0045; H01M 10/441; H01M 2010/4278; H02J 7/0021; H01M 10/425

(57) ABSTRACT

The present application discloses a battery unit maintenance system for charging a plurality of batteries. The battery unit maintenance system includes a charging module having a first mating connector and a plurality of battery docking ports, each docking port configured to operatively connect to one of the plurality of batteries. The battery unit maintenance system also includes a processor configured to send information to and receive information from the batteries when the batteries are retained in the charging module. The battery unit maintenance system further includes an accessory portion having a second mating connector and a power connector, the second mating connector configured to releasably mate with the first mating connector.

### BACKGROUND OF THE INVENTION

The subject matter disclosed herein relates to battery maintenance. In particular, the present invention relates to a configurable system for battery unit maintenance.

Wearable, wireless patient monitoring sensors may be powered by re-chargeable battery units. As these sensors may be worn in a variety of different care environments and in different operating cultures, there are various needs for the maintenance, including charging, of the battery units that power these sensors. Therefore, a charging solution that enables scaling of the charging unit to meet multiple clinical needs is desired. For example, local bed-side charging stations are desired to provide easily accessible battery charging at an arms' length from a patient. In this context, a small sized charger would be desirable, as well as one that may be mounted to a pole or table edge. Yet, where space is less constrained, a larger charging solution for an entire patient room or ward with a plurality of patients may be more suitable.

A battery charging system comprising a universal charger module configurable with a variety of accessory portions may enable higher production volume, bring about cost savings, and simplify install base product handling. Modularity enables flexibility to modify the product to meet varying needs of care environments and cultures.

The above-mentioned shortcomings, disadvantages and problems are addressed herein which will be understood by reading and understanding the following specification.

### BRIEF DESCRIPTION OF THE INVENTION

In an embodiment, a battery unit maintenance system for charging a plurality of batteries is provided. The battery unit maintenance system comprises a charging module having a first mating connector and a plurality of battery docking ports, each docking port configured to operatively connect to one of the plurality of batteries. The battery unit maintenance system further comprises a processor configured to send information to and receive information from the batteries when the batteries are retained in the charging module. The battery unit maintenance system further comprises an accessory portion having a second mating connector and a power connector, the second mating connector configured to releasably mate with the first mating connector.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of a battery unit maintenance system in accordance with an embodiment of the disclosure;

FIG. 2 is a perspective view of a battery unit maintenance system in accordance with an embodiment of the disclosure;

FIG. 3 is a perspective view of a battery unit maintenance system in accordance with an embodiment of the disclosure;

FIG. 4 is a perspective view of a battery unit maintenance system in accordance with an embodiment of the disclosure;

FIG. 5 is a perspective view of a battery unit maintenance system in accordance with an embodiment of the disclosure;

FIG. 6 is a perspective view of a battery unit maintenance system in accordance with an embodiment of the disclosure; and

FIG. 7 is a perspective view of a battery unit maintenance system in accordance with an embodiment of the disclosure.

### DETAILED DESCRIPTION OF THE INVENTION

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives, and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

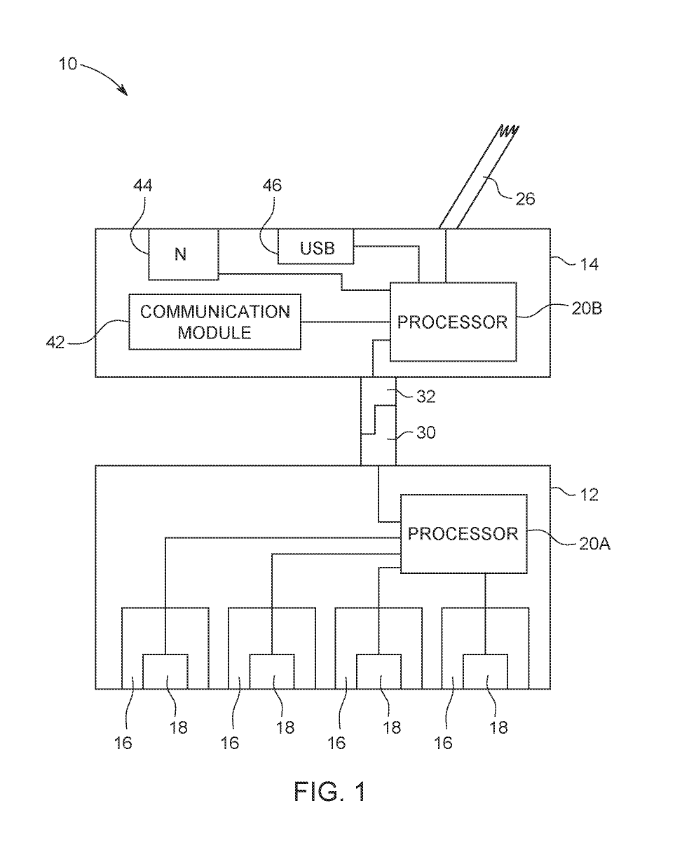

Referring to FIG. 1, a battery unit maintenance system 10 for charging a plurality of batteries (not shown) is depicted according to an embodiment. The battery unit maintenance system 10 comprises a charging module 12 and an accessory portion 14.

The charging module 12 and the accessory portion 14 are configured to releasably mate with one another. The charging module 12 comprises a first mating connector 30. The accessory portion 14 comprises a second mating connector 32. The first mating connector 30 and the second mating connector 32 are configured to releasably mate with one another. In one embodiment, when mated, the charging module 12 and the accessory portion 14 may be connected mechanically and electrically. For example, first mating connector 30 and second mating connector 32 are Universal Serial Bus (USB) type connectors. In another example, first mating connector 30 and second mating connector 32 comprise a plurality of galvanic pins. In another embodiment, when mated, the first mating connector 30 and the second mating connector 32 may be mechanically connected but configured to transfer data and power optically. In yet another embodiment, when mechanically mated, the first mating connector 30 and the second mating connector 32 transfer data wireless via inductive coupling.

It should be appreciated, however, that other embodiments of the first and second mating connectors 30, 32 are envisioned within the scope of this disclosure. For example, in an embodiment, the charging module may comprise a plurality of first mating connectors 30 and the accessory portion 14 may comprise a plurality of second mating connectors 32. Within the plurality of first mating connectors 30, at least one connector may be configured as an electrical connector and at least one connector may be configured as a physical connector. Within the plurality of second mating connectors 32, at least one connector may be configured as an electrical connector and at least one connector may be configured as a mechanical connector.

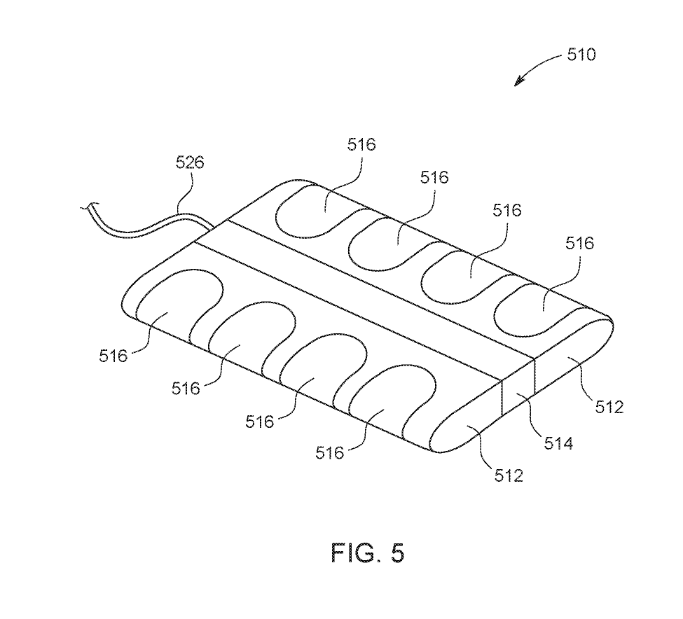

In another embodiment (as depicted in FIGS. 5-7), the accessory portion 14 may comprise a plurality of second mating connectors, so that a plurality of charging modules may be operatively connected to the accessory portion. Various configurations or arrangements may be envisioned and will be described infra with respect to embodiments depicted in FIGS. 5-7.

The charging module 12 comprises a plurality of battery docking ports 16. In the embodiment depicted in FIG. 1, the charging module 12 comprises four battery docking ports 16. It should be appreciated that other embodiments of the charging module 12 may be envisioned within the scope of this disclosure. For example, the charging module 12 may comprise three docking ports. In another example, the charging module 12 may comprise five to eight docking ports. In yet another example, the charging module 12 may comprise ten to fifteen docking ports.

Each docking port 16 is configured to releasably retain a battery. In an embodiment, the docking port 16 may be specifically sized and shaped to receive and retain a battery. Each docking port 16 is also configured to operatively connect a battery (not shown) to the charging module 12. As depicted in FIG. 1, the docking port 16 may be operatively connected to the battery via a connector 18. In one embodiment, connector 18 is a galvanic connector. In another embodiment, the connector 18 is a Universal Serial Bus (USB) type connector. It should be appreciated that as envisioned by this disclosure, the connector 18 may any type of connector that is configured to communicate with and pass electric power to the battery. It should also be appreciated, however, that the docking port 16 may be operatively connected to a battery wirelessly via, for example, inductive coupling.

The battery unit maintenance system 10 may comprise a processor 20. The processor 20 may be configured to receive information from batteries retained in the charging module 12. The processor 20 may be configured to receive at least one of elapsed time of battery use, number of times the battery has been charged, number of times the battery has been physically dropped, estimated life expectancy of the battery, current software version installed on the battery, battery identification, or any combination thereof.

The processor 20 may also be configured to send information to batteries retained in the charging module 12. For example, the processor 20 may be configured to send a software update to the batteries.

In the embodiment depicted in FIG. 1, the charging module 12 comprises a processor 20A and the accessory portion 14 comprises a processor 20B. It should be appreciated that other embodiments of the configuration of the processor 20 may be envisioned within the scope of this disclosure. For example, in one embodiment, the system 10 comprises a single processor 20 comprised in the charging module 12. In another embodiment, the system 10 comprises a single processor 20 comprised in the accessory portion 14.

The accessory portion 14 may comprise a power cord 26. The power cord 26 is configured to supply power to the accessory portion 14 and to the charging module 12 when the charging module 12 is operatively connected to the accessory portion 14.

The accessory portion 14 may comprise a communication module 42 operationally connected to the processor 20 and configured to send and receive information wirelessly. It should be noted that the communication module 42 may comprise any suitable wireless communication technology, such as a device to device communication method (e.g., Bluetooth, Infrared control, radio frequency control, etc.), such as to create a personal area network, or a broadcast type of communication method (e.g., WiFi, network, etc.). Information sent or received by the processor 20 via the communication module 42 may include, but not be limited to elapsed time of battery use, number of times the battery has been charged, number of times the battery has been physically dropped, estimated life expectancy of the battery, current software version installed on the battery, software updates, battery identification, or any combination thereof.

The accessory portion 14 may also comprise a hospital network connector 44 and a Universal Serial Bus (USB) connector 46. Both the hospital network connector 44 and the USB connector 46 may be configured to send and receive information from the processor 20. Information sent or received by the processor 20 via the hospital network connector 44 or the USB connector 46 may include, but not be limited to elapsed time of battery use, number of times the battery has been charged, number of times the battery has been physically dropped, estimated life expectancy of the battery, current software version installed on the battery, software updates, battery identification, or any combination thereof.

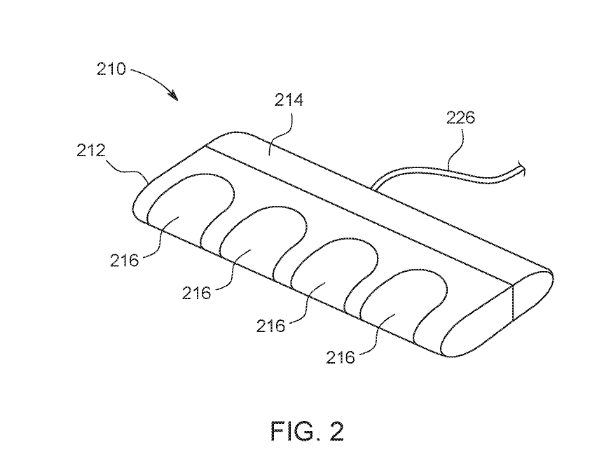

Referring to FIG. 2, a battery unit maintenance system 210 is shown in accordance with an embodiment. The system 210 comprises a charging module 212 operatively connected to an accessory portion 214. The charging module comprises a plurality of battery docking ports 216, each configured to receive a battery (not shown). The accessory portion 214 comprises a power cord 226 configured to supply power to the system 210 and charge batteries (not shown) when retained in the charging module 212.

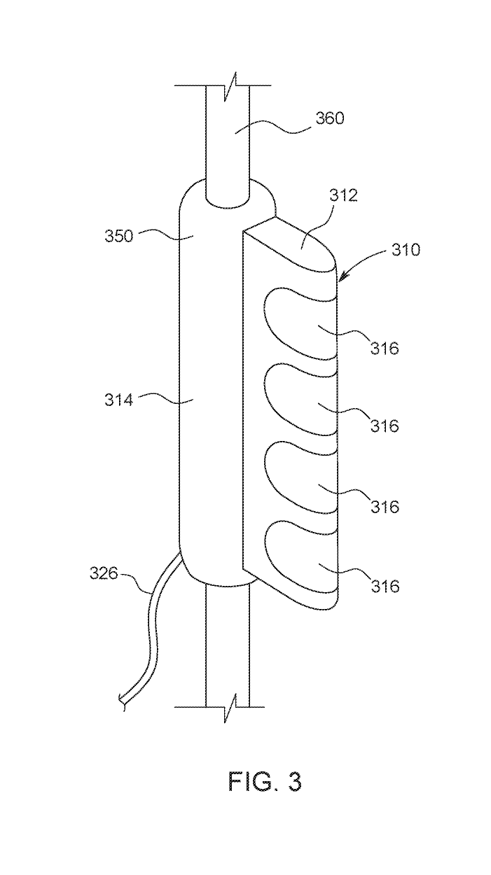

Referring to FIG. 3, a battery unit maintenance system 310 is shown in accordance with an embodiment. The system 310 comprises a charging module 312 and accessory portion 314. The charging module 312 may be operatively connected to the accessory portion 314 via first and second mating connectors (not shown). The accessory portion 314 comprises a power cord 326 configured to supply power to the system 310 and charge batteries (not shown) when retained in battery docking ports 316 of the charging module 312.

The accessory portion 314 may comprise a mounting device 350 configured to releasably connect the system 310 at a desired location. In the embodiment depicted in FIG. 3, the mounting device 350 is a cylinder configured to attach the system 310 to a pole 360. The pole 360 may be an accessory pole such an IV pole, or may be a patient care device. The mounting device 350 may also comprise a fastener (not pictured) such as a clamp or a screw to assist in attaching the system 310 to the pole 360.

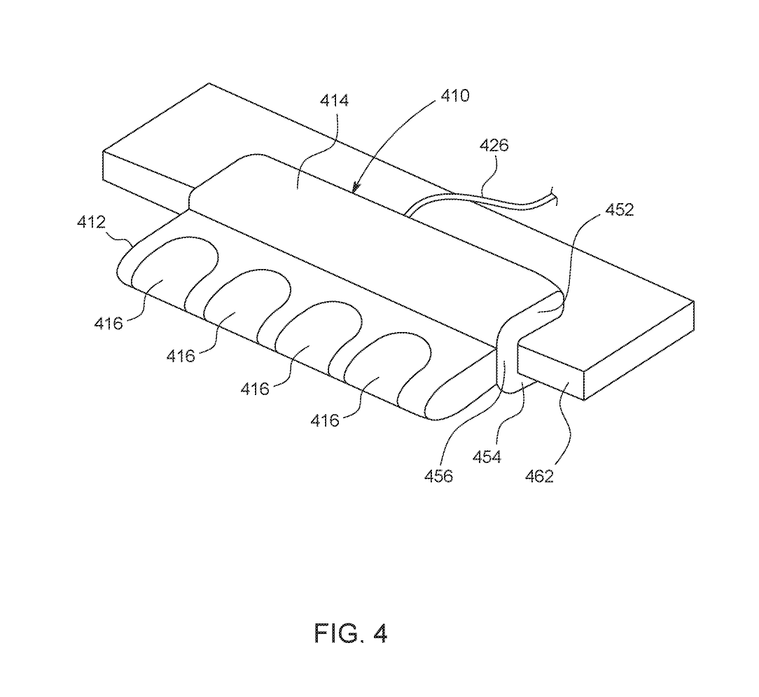

Referring to FIG. 4, a battery unit maintenance system 410 is shown in accordance with an embodiment. The battery unit maintenance system 410 comprises a charging module 412 operatively connected to an accessory portion 414. The accessory portion 414 comprises a power cord 426 configured to supply power to the system 410 and charge batteries (not shown) when retained in the charging module 412.

The system 410 is generally similar to system 310, with the exception of mounting device 450. In the embodiment depicted in FIG. 4, the mounting device 450 is configured to releasably attach the system 410 to a surface 462 such as a table, a rail, a cart, or a patient care device. The mounting device 450 comprises two arms 452, 454 that extend from a center portion 456 to wrap about an edge of a surface 462. In one embodiment, the arms 452, 454 may be comprised of a flexible material with shape memory. In another embodiment, the arms 452, 454 may be comprised of a material with a high coefficient of friction such as rubber. In yet another embodiment, the arms 452, 454 are secured to the surface 462 with a fastener such as a clamp or a screw.

Referring to FIG. 5, a battery unit maintenance system 510 is shown in accordance with an embodiment. The system 510 comprises a charging module 512 operatively connected to an accessory portion 514. It should be appreciated that a plurality of charging modules 512 may be connected to a single accessory portion 514. For example, as depicted in FIG. 5, the accessory portion 514 is operatively connected to two charging modules 512. It should be appreciated that various configurations of the second mating connectors (not shown) are envisioned in order to accommodate a plurality of charging modules 512. In the embodiment depicted in FIG. 5, second mating connectors are on opposing sides of accessory portion 514. In another example, second mating connectors may be on adjacent sides of accessory portion 514. In yet another example, second mating connectors may be adjacent one another on a single side or surface of accessory portion 514. The accessory portion 514 comprises a power cord 526 configured to supply power to the system 510 and charge batteries (not shown) when retained in the charging module 512.

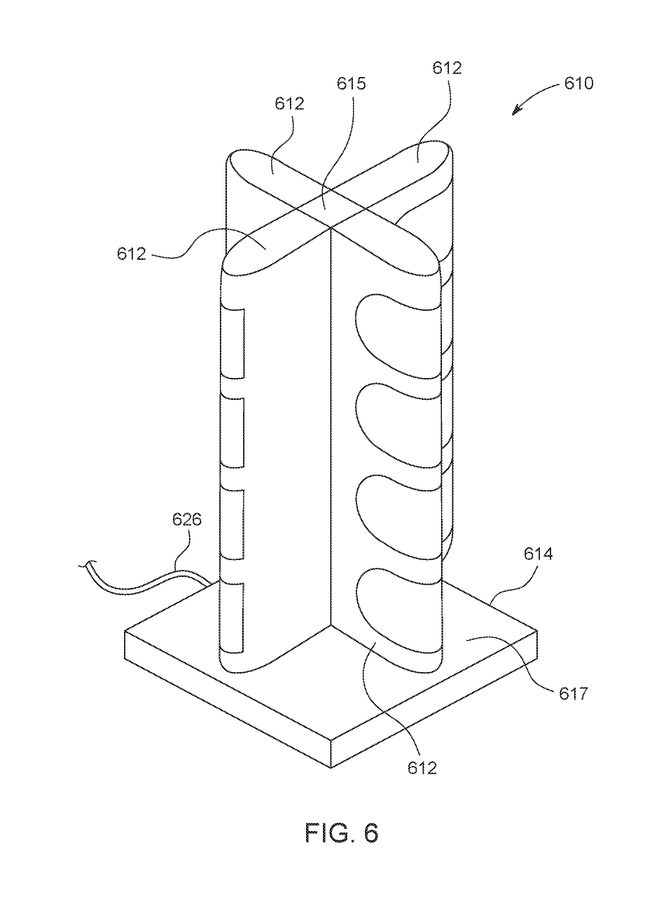

Referring to FIG. 6, a battery unit maintenance system 610 is shown in accordance with an embodiment. The system 610 comprises a plurality of charging modules 612 connected to an accessory portion 614. In the embodiment depicted in FIG. 6, the system 610 comprises four charging modules 612, each operatively connected to a single accessory portion 614. However, it should be appreciated that various other configurations of charging modules 612 with respect to the accessory portion 614 are envisioned within the scope of this disclosure. For example, the accessory portion 614 may be configured to mate with three charging modules 612. Yet, in another example, the accessory portion 614 may be configured to mate with six charging modules 612.

In the embodiment depicted in FIG. 6, the accessory portion 614 comprises a base 617 and an arm 615 extending generally perpendicular from the base 617. The arm 615 comprises at least four second mating connectors (not shown), each second mating connector configured to releasably mate with a first mating connector of any of the charging modules 612. It should be appreciated that various configurations of the second mating connectors (not shown) are envisioned in order to accommodate a plurality of charging modules 612. The accessory portion 614 comprises a power cord 626 configured to supply power to the system 610 and charge batteries (not shown) when retained in the charging module 612.

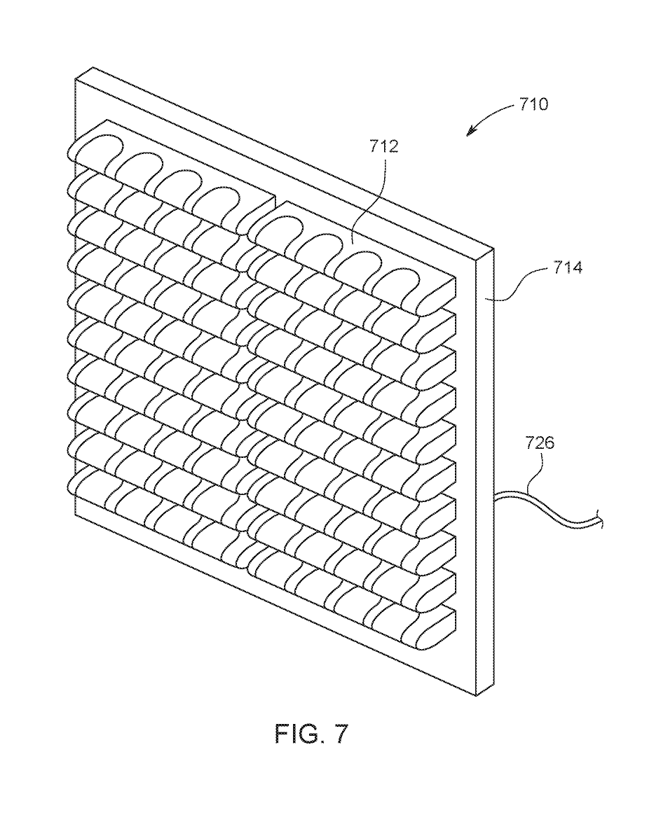

Referring to FIG. 7, a battery unit maintenance system 710 is shown in accordance with an embodiment. The system 710 comprises a plurality of charging modules 712 operatively connected to an accessory portion 714. In the embodiment depicted in FIG. 7, twenty charging modules 712 are operatively connected to the accessory portion 714. It should be appreciated that the number of charging modules 712 connected to accessory portion 714 may vary in accordance with various embodiments of the disclosure. For example, the battery unit maintenance system 710 may comprise one accessory portion 714 and ten charging modules 712.

Power is supplied to the battery unit maintenance system 710 via power cord 726. The accessory portion 714 may comprise a mounting device 750 configured to releasably mount the system 710 at a desired location, such as a wall, desk, or other surface configured to support the system 710. Mounting device 750 may comprise a fastener such as a clamp, a screw, an adhesive, or a combination thereof.

Referring now to FIGS. 1-7, the systems 10, 210, 310, 410, 510, 610, 710 comprise a charging module 12, 212, 312, 412, 512, 612, 712 that is universal to any of the systems 10, 210, 310, 410, 510, 610, 710. As the charging module 12, 212, 312, 412, 512, 612, 712 may be operatively connected to any of the accessory portions 14, 214, 314, 414, 514, 614, 714, flexibility is provided to meet the needs of a variety of care environments and cultures.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A battery unit maintenance system for charging a plurality of batteries, comprising:
a charging module having a first mating connector and a plurality of battery docking ports, each docking port configured to operatively connect to one of the plurality of batteries;
a processor configured to send information to and receive information from the batteries when the batteries are retained in the charging module; and
an accessory portion having a second mating connector and a power connector, the second mating connector configured to releasably mate with the first mating connector.

2. The battery unit maintenance system of claim 1, wherein when the first and second connectors are mated, the charging module and the accessory portion are connected mechanically and electrically.

3. The battery unit maintenance system of claim 1, wherein the charging module includes the processor configured to send information to and receive information from the batteries retained in the charging module.

4. The battery unit maintenance system of claim 3, wherein the processor is configured to receive at least one of elapsed time of use, number of times charged, number of physical drops, estimated life expectancy, battery identification, and current software version from the batteries.

5. The battery unit maintenance system of claim 3, wherein the processor is configured to send a software update to the batteries.

6. The battery unit maintenance system of claim 1, wherein the accessory portion includes the processor configured to send information to and receive information from the batteries retained in the charging module when the charging module and the accessory portion are mated.

7. The battery unit maintenance system of claim 6, wherein the processor of the accessory portion is configured to receive at least one of elapsed time of use, number of times charged, number of physical drops, estimated life expectancy, battery identification, and current software version from the batteries.

8. The battery unit maintenance system of claim 6, wherein the processor of the accessory portion is configured to send a software update to the batteries.

9. The battery unit maintenance system of claim 1, wherein the accessory portion comprises a communication module configured to send and receive information wirelessly.

10. The battery unit maintenance system of claim 9, wherein the information comprises elapsed time of use, number of times charged, number of physical drops, estimated life expectancy, battery identification, and current software version from the battery.

11. The battery unit maintenance system of claim 1, wherein the accessory portion comprises a USB connector.

12. The battery unit maintenance system of claim 1, wherein the accessory portion comprises a hospital network connector.

13. The battery unit maintenance system of claim 1, wherein the accessory portion includes a mounting device to releasably connect the accessory portion at a desired location.

14. The battery unit maintenance system of claim 13, wherein the desired location is a patient care device.

15. The battery unit maintenance system of claim 1, wherein the accessory portion includes two second mating connectors and is configured to mate with two charging modules.

16. The battery unit maintenance system of claim 1, wherein the accessory portion includes four second mating connectors and is configured to mate with four charging modules.

17. The battery unit maintenance system of claim 1, wherein the accessory portion includes ten second mating connectors and is configured to mate with ten charging modules.
